(19) United States
(12) Patent Application Publication
(10) Pub. No.: US 2008/0092226 A1
(43) Pub. Date: Apr. 17, 2008

(54) PRE-REGISTRATION SECURE AND AUTHENTICATEDSESSION LAYER PATH ESTABLISHMENT

(75) Inventors: Robert Horvath, Arlington Heights, IL (US); Michael F. Coulas, Buffalo Grove, IL (US); Bradley F. Jentz, Barrington, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/852,656

(22) Filed: Sep. 10, 2007

Related U.S. Application Data
(60) Provisional application No. 60/829,164, filed on Oct. 12, 2006.

(51) Int. Cl. G06F 21/20

(52) U.S. Cl. 726/12

(57) ABSTRACT

A system and method for establishing a secure and authenticated session layer path between user equipment (102) and a security proxy (112), such as a serving call session control function (116). A communications session is established at a user equipment node (102), prior to registering with the security proxy (112). The user equipment (102) subscribes, through the communications session prior to registering with the security proxy (112), to an event package from the security proxy (112). A secure and authenticated session layer path (426) is established, based upon the subscription, through the communications session from the user equipment node to the security proxy (112) and therefore the serving call session control function (116). A session initiation protocol session (442) is originated, at the user equipment node (102), over the secure and authenticated session layer path (426) based upon authentication provided by the secure and authenticated session layer path (426).

### CROSS-REFERENCE TO RELATED APPLICATION

This application claims priority from provisional application Ser. No. 60/829,164, entitled “Pre-registration Secure and Authenticated Session Layer Path Establishment,” filed Oct. 12, 2006, which is commonly owned and incorporated herein by reference in its entirety.

### FIELD OF THE INVENTION

The present invention generally relates to the field of data communications, and more particularly relates to authenticating user equipment and controlling access of user equipment to network services.

### BACKGROUND OF THE INVENTION

The current IP Multimedia Subsystem (IMS) specifications do not effectively support session mobility. Session mobility is impeded under the current IMS specifications due to a heavy reliance on performing a SIP registration before an INVITE or any other SIP request can be sent. With IMS, an INVITE cannot be sent to originate or refresh a session without having previously registered the User Equipment's contact address. However, a registration of a new contact address causes the old contact address to be deregistered and, if there are active sessions using the old contact address, those active sessions are immediately released. This creates a chicken and egg problem. To move an IMS session to a new contact address, such as via a target refresh or an INVITE with replace operation, one must first register that contact address, which in turn causes the session to be released.

The REGISTER operation in current IMS implementations is used to perform the following functions: 1) authentication; 2) registering a binding of address of record to contact address; 3) creation of a secure path for fast establishment of future sessions; and 4) creation of a registration event which can be subscribed to by the UE or P-CSCF for current registration status.

Performing these multiple functions through the REGISTER operation causes a strong coupling between IMS registration and IMS security. This coupling imposes the following limitations on access to the IM core by IMS users: 1) An IMS user cannot originate IMS sessions or send any other SIP request for that matter, using an unregistered public user identity; 2) An IMS user cannot initiate IMS sessions or send SIP requests using a new contact address without first registering that contact address; and 3) The IMS core cannot manage an IMS user's access security independently of the user's registration state. The last limitation results in undesirable side-effects such as releasing a session when the public user identity it uses is either deregistered or re-registered using a new contact address.

Therefore a need exists to overcome the problems with the prior art as discussed above.

### SUMMARY OF THE INVENTION

Briefly, in accordance with one aspect of the present invention a method for establishing a secure and authenticated session layer path between a user equipment node and a security proxy includes transmitting to a security proxy from a user equipment node, prior to registering with the security proxy, a session initiation protocol request other than a REGISTER request. The method further includes responding, from the user equipment node prior to registering with the security proxy, to a session initiation protocol challenging response message with an authenticating response containing information sufficient to authenticate the user equipment node with the security proxy and sufficient to create a secure and authenticated session layer path between the user equipment node and the security proxy. The session initiation protocol challenging response message was sent from the security proxy in response to the transmitting.

In accordance with another aspect of the present invention, a user equipment device for use with a wireless data communications system includes a communications session controller that is adapted to transmit to a security proxy, prior to registering with the security proxy, a session initiation protocol request other than a REGISTER request. The communications session controller is further adapted to respond, prior to registering with the security proxy, to a session initiation protocol challenging response message with an authenticating response containing information sufficient to authenticate the user equipment node with the security proxy and sufficient to create a secure and authenticated session layer path between the user equipment node and the security proxy, wherein the session initiation protocol challenging response message was sent from the security proxy in response to the transmitting.

In accordance with another aspect of the present invention, a method for establishing an IP Multimedia subsystem session between a security proxy and a user equipment node includes accepting, at a security proxy from a user equipment node, a session initiation protocol request other than a REGISTER request. The method also includes responding to the a session initiation protocol request by sending a challenging response message to the user equipment node. The method further includes accepting, at the security proxy from a user equipment node, an authenticating response containing information sufficient to authenticate the user equipment node. The method also includes establishing a secure and authenticated session layer path between the security proxy and the user equipment node based upon the authenticating response.

### BRIEF DESCRIPTION OF THE DRAWINGS

The accompanying figures where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates a block diagram of a wireless data communications device operating with a wireless Session Initiation Protocol (SIP) data network in accordance with one embodiment of the present invention.

FIG. 2 illustrates a processing flow diagram for a subscription based session initiation processing for an IP Multimedia Subsystem (IMS) session, in accordance with one embodiment of the present invention.

FIG. 3 illustrates a processing flow diagram for a subscription based session initiation handoff, in accordance with one embodiment of the present invention.

FIG. 4 illustrates a subscription based session initiation handoff message exchange diagram for an IP Multimedia Subsystem (IMS) session in accordance with one embodiment of the present invention

FIG. 5 illustrates a security proxy secure and authenticated session layer path set-up processing, in accordance with one embodiment of the present invention.

FIG. 6 illustrates a block diagram of a security proxy processor in accordance with one embodiment of the present invention.

FIG. 7 illustrates a User Equipment (UE) processor in accordance with one embodiment of the present invention.

### DETAILED DESCRIPTION

As required, detailed embodiments of the present invention are disclosed herein; however, it is to be understood that the disclosed embodiments are merely examples of the invention, which can be embodied in various forms. Therefore, specific structural and functional details disclosed herein are not to be interpreted as limiting, but merely as illustrative examples for the claims and as a representative basis for teaching one skilled in the art to variously employ the present invention in virtually any appropriately detailed structure. Further, the terms and phrases used herein are not intended to be limiting; but rather, to provide an understandable description of embodiments of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically.

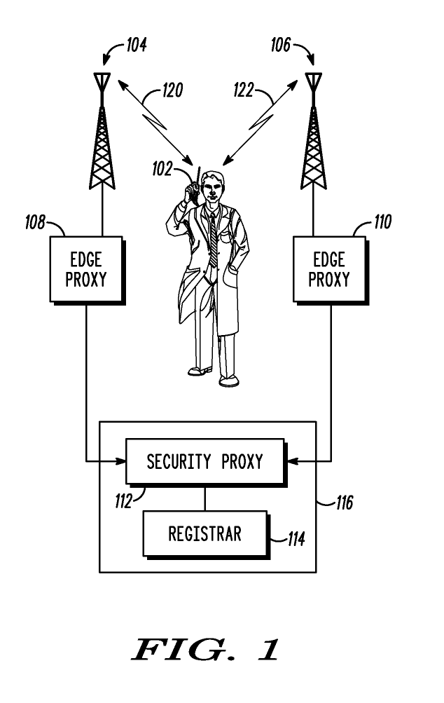

FIG. 1 illustrates a block diagram of a wireless data communications device operating with a wireless Session Initiation Protocol (SIP) data network 100 in accordance with one embodiment of the present invention. The wireless SIP data network 100 of this example includes a security proxy 112 that is in communications with a registrar 114. The security proxy 112 and registrar in this illustration correspond to a serving call session control function 116 of an IMS implementation. The security proxy 112 of one embodiment is connected to one or more edge proxy devices, such as a first edge proxy 108 and a second edge proxy 110. The edge proxy devices of one embodiment communicate data to antenna towers, such as a first antenna tower 104 and a second antenna tower 106 to wirelessly communicate that data to one or more user equipment devices. The illustrated edge proxy devices correspond to proxy call session control function devices of the IMS implementation.

The illustrated example shows two edge proxies that are able to communicate with a wireless communications User Equipment (UE) device, or node, 102. The UE device 102 of one embodiment corresponds to a UE node of an IMS implementation. Although the use of wireless communications systems is illustrated, further embodiments of the present invention operate using wired connections, or a combination of wired and wireless connections, to form multiple connections between multiple edge proxies that are used to provide data communications services to a UE node.

In the illustrated example of a wireless SIP data network 100, a first antenna tower 104 is connected to a first edge proxy 108, which corresponds to a first Proxy Call Session Control Function (P-CSCF) for the IMS implementation. A second antenna tower 106 is connected to a second edge proxy 110, which corresponds to a second Proxy Call Session Control Function (P-CSCF). In accordance with the conventional architecture for the IMS infrastructure, the P-CSCFs are in communications with a Serving Call Session Control Function (S-CSCF) 116, which contains a security proxy 112 and a registrar 114. Although only two P-CSCFs are illustrated as communicating with the S-CSCF 116, it is understood that a number of P-CSCFs are able to communicate with the S-CSCF, and that a number antenna towers are able to be in communications with each P-CSCF, as is currently defined for the IMS infrastructure architecture. In some embodiments of the present invention, some of the edge proxies, e.g., P-CSCFs of an IMS implementation or equivalent processors implementing other network communications standards, are part of a visited network as is defined for a conventional SIP or IMS infrastructure.

The UE device 102 is able to establish a first wireless communications connection 120 with the first antenna tower 104 and a second wireless communications connection 122 with the second antenna tower 106. Each of these wireless communications connections is able to communicate digital data conveying SIP and/or IMS sessions and services between the UE device 102 and each respective antenna tower. The UE device 102 of this example is able to establish IMS connections and sessions with either or both of the edge proxies, e.g., the first edge proxy 108 and the second edge proxy 110, through their respective antenna towers. The edge proxies then communicate this data with the security proxy 112 and registrar 114 of the S-CSCF 116. These IMS connections are able to support, for example, various digital communications protocols such as sessions controlled by the Session Initiation Protocol (SIP).

One embodiment of the present invention initiates configuring an IMS session with an S-CSCF 116 by establishing an authenticated and secure session layer path to the S-CSCF 116 in conjunction with subscribing to an event package. Some embodiments of the present invention establish these connections by subscribing to specifically identified event packages. Examples of event packages that are subscribed to by user equipment (UE) in conjunction with establishing a secure and authenticated session layer path with an S-CSCF 116, and through which IMS and/or SIP services may be initiated, include either a specially defined “security event package,” a conventional REGISTER event package, or any other suitable package. Further embodiments of the present invention are able to subscribe to any suitable event package in conjunction with establishing a secure and authenticated session layer path to a security proxy, such as the S-CSCF 116. In one embodiment, a security event package is unique event package that is associated with establishing secure and authenticated session layer paths established prior to registration.

Yet further embodiments of the present invention are able to establish a secure and authenticated session level path between a UE device and a S-CSCF by configuring the S-CSCF to respond to any SIP session origination method, such as an INVITE method, by sending a “401 Unauthorized” message as a challenging response message. This results in configuring a time limited authenticated session whose duration equals the time of the authentication of the UE device. In addition to configuration of the secure and authenticated session level path for the duration of the session corresponding to the INVITE method, these embodiments of the present invention further subscribe, through the secure and authenticated session layer path prior to registering with the security proxy, to an event package from the security proxy 112. One embodiment subscribes by sending an SIP SUBSCRIBE request to the security proxy 112. The security proxy 112 of these embodiments is configured to respond to the SUBSCRIBE request by extending a lifetime of the secure and authenticated session layer path beyond a lifetime of a session initiated by the session initiation protocol INVITE request or the other previously sent SIP request. One embodiment responds to this SUBSCRIBE request by sending a session initiation protocol NOTIFY message that contains a list of all authorized universal resource identifiers for that UE device 102 and a lifetime of the secure and authenticated session layer path.

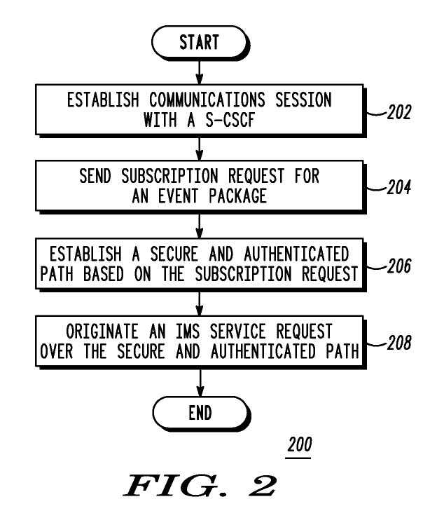

FIG. 2 illustrates a processing flow diagram for a subscription based session initiation processing 200 for an IP Multimedia Subsystem (IMS) session in accordance with one embodiment of the present invention. The subscription based session initiation processing flow 200 begins by establishing, at step 202, an insecure and unauthenticated communications session layer path between the UE device 102, through the first edge proxy 108, and the security proxy 112, such as is included in the S-CSCF 116. One embodiment establishes this communications session by configuring a wireless communications connection with an antenna tower, such as the first wireless connection 120 to antenna tower 104, by conventional means. Data communicated over that wireless connection is then able to be communicated through the first edge proxy 108, which is equivalent to a first P-CSCF, to the S-CSCF 116 according to conventional IMS protocols as are modified in light of the present discussion.

The subscription based session initiation processing 200 continues by the UE device 102 sending, at step 204, a subscription request, such as a session initiation protocol SUBSCRIBE request, to the security proxy 112, within the S-CSCF 116, for an event package. In one embodiment, the subscription request is communicated to a P-CSCF, such as the edge proxy 108, and the processing of that P-CSCF forwards the SUBSCRIBE request to a proper S-CSCF, such as the S-CSCF 116. One embodiment of the present invention allows IMS subscription requests to be sent and accepted by the S-CSCF 116 prior to registration of the UE device 102 with the S-CSCF 116.

The subscription based session initiation processing 200 continues by establishing, at step 206, a secure and authenticated session layer path between the UE 102 and the S-CSCF 116, and more particularly the security proxy 112, based on the subscription request. The message exchange and processing associated with establishing this secure and authenticated session layer path is described in further detail below. One embodiment of the present invention allows the establishment of a secure and authenticated session layer path prior to registration of the UE device 102 with the S-CSCF 116.

After a secure and authenticated session layer path has been established to the security proxy 112, which is included in the S-CSCF 116, the subscription based session initiation processing 200 continues by originating, at step 208 and by the UE device 102, an IMS service request over that secure and authenticated session layer path. Examples of IMS service requests originated by the UE device 102 of one embodiment of the present invention include communications sessions initiated and maintained by Session Initiation Protocol (SIP) exchanges. One embodiment of the present invention allows SIP REGISTER messages as well as INVITE, SUBSCRIBE and other such messages.

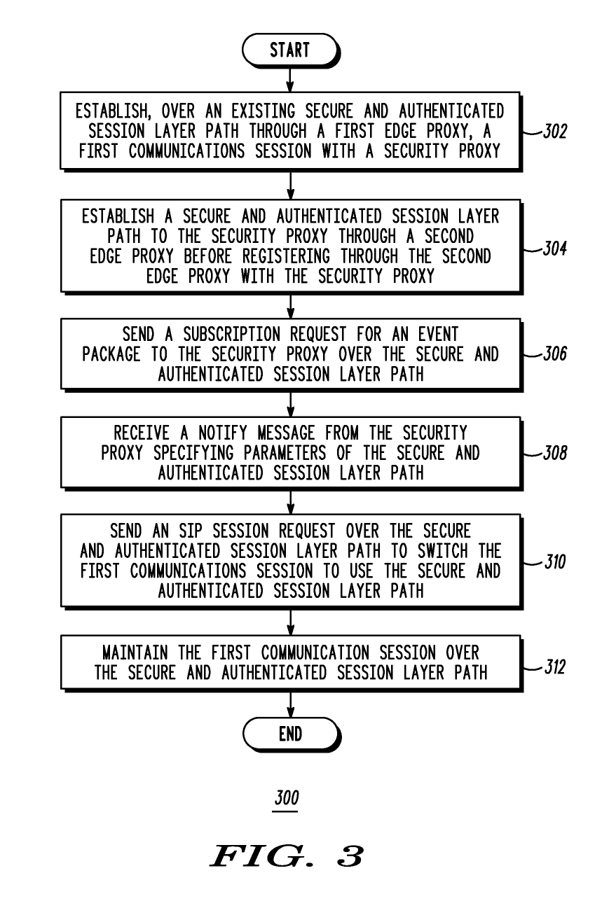

FIG. 3 illustrates a processing flow diagram for a subscription based session initiation handoff 300 in accordance with one embodiment of the present invention. The subscription based session initiation handoff 300 begins by establishing, at step 302, over an existing secure and authenticated session layer path through a first edge proxy 108, a first communications session between the UE device 102 and a security proxy 112, such as is included in the S-CSCF 116. The subscription based session initiation handoff 300 then establishes, at step 304, a secure and authenticated session layer path between the UE device 102 and the security proxy 112 through a second edge proxy 110 before registering the UE device through the second edge proxy 110 with the registrar 114. One embodiment of the present invention establishes this path according to the subscription based session initiation processing 200. As discussed above, one embodiment of the present invention allows user equipment to establish communications sessions with S-CSCF prior to the user equipment's registration with the S-CSCF.

At step 306 of the subscription based session initiation handoff 300, the UE device 102 sends a subscription request for an event package to the security proxy 112 using the secure and authenticated session layer path through the second edge proxy 110. As described above, and in more detail below, subscribing to an event package with the security proxy 112 allows the UE device to send and receive SIP sessions requests through that edge proxy. In one embodiment, this subscription request includes a SIP SUBSCRIBE message that specifies at least one Universal Resource Indicator (URI) that is associated with the user equipment node 102.

At step 308 of the subscription based session initiation handoff 300, the UE device 102 receives a NOTIFY message from the security proxy 112, included within S-CSCF 116, that specifies parameters of the secure and authenticated session layer path. This NOTIFY message in one embodiment includes, for example, all URIs that the UE device is authorized to use (including implicitly authenticated URIs), the lifetime of the secure and authenticated session layer path, and other such information.

Once the UE device 102 has subscribed to an event package and has received the NOTIFY message, the UE device 102, at step 310 of the subscription based session initiation handoff 300, sends an SIP service request over the secure and authenticated session layer path to switch the first communications session to use the secure and authenticated session layer path using the second edge proxy 110. This SIP service request, for example, includes an SIP INVITE with replace message to switch the IMS service session to operate through the newly established secure and authenticated session layer path. After sending this IMS service request, the subscription based session initiation handoff 300 maintains, at step 312, the first communications session, for example the IMS service session, over the secure and authenticated session layer path through the second edge proxy 110. In one embodiment, the UE device 102 is able to initiate and terminate any SIP session through either the secure and authenticated session layer path with the S-CSCF 116 through either the first edge proxy 108 or the second edge proxy 110. Further, the UE device is able to terminate the secure and authenticated session layer path through the first edge proxy 108 and continue communications only through the secure and authenticated session layer path through the second edge proxy 110 to the security proxy 112 and associated S-CSCF 116.

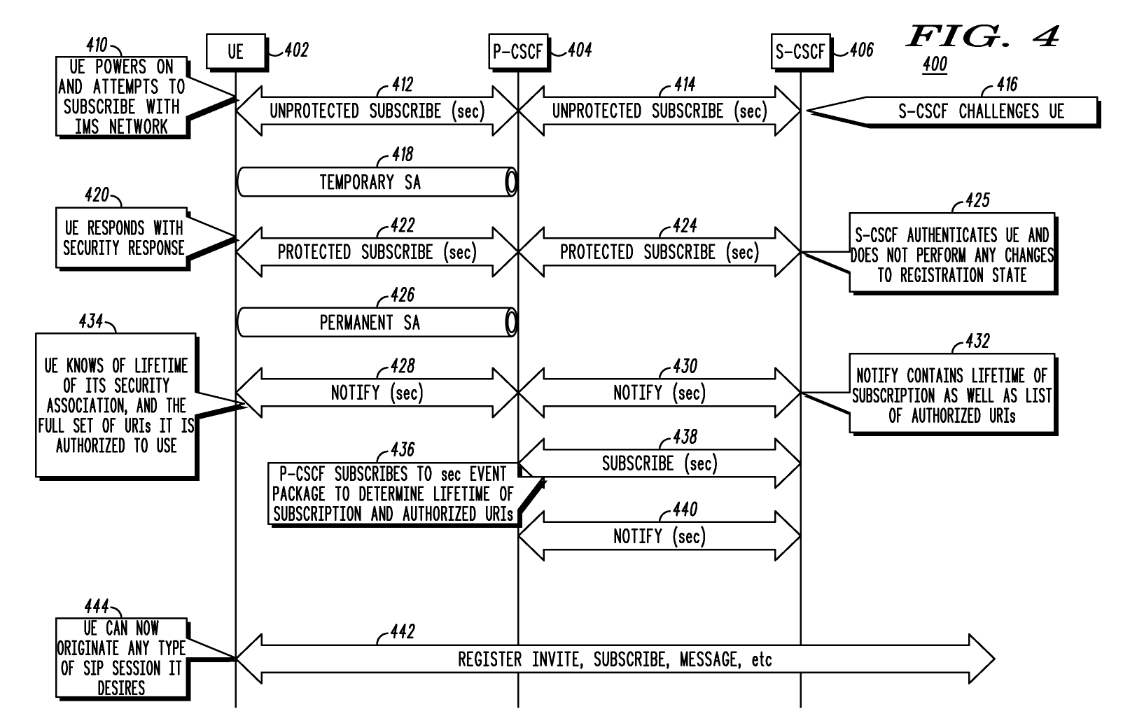

FIG. 4 illustrates a subscription based session initiation handoff message exchange 400 diagram for an IP Multimedia Subsystem (IMS) session in accordance with one embodiment of the present invention. The subscription based session initiation handoff message exchange 400 illustrates communications session control message exchanges that occur between a User Equipment (UE) device 402, a Proxy Call Session Control Function (P-CSCF) 404 and a Server Call Session Control Function (S-CSCF) 406 as time progresses down the vertical axis.

The subscription based session initiation handoff message exchange 400 begins when the UE device 402 powers on and attempts to subscribe with an IMS network. The UE device 402 transmits an unprotected SUBSCRIBE request 412 to the P-CSCF 404, which forwards the request 414 to the proper S-CSCF 406. In response to receiving the SUBSCRIBE request 414, the S-CSCF responds by challenging 416 the UE device 402. This exchange results in the establishment of a temporary Security Association (SA) 418 between the UE device 402 and the P-CSCF 404. Once this temporary security association is established, the subscription based session initiation handoff message exchange 400 continues with the UE device 402 responding with a security response 420 that includes an authenticating response. The UE device 402 then sends a protected SUBSCRIBE request 422 to the P-CSCF 404, which forwards the protected SUBSCRIBE request 424 to the proper S-CSCF 406. The S-CSCF authenticates 425 the UE device 402 and does not perform any changes to the registration state of the UE device 402 with this S-CSCF or other S-CSCFs. This results in a permanent security association (SA) 426 being established between the UE device 402 and the P-CSCF 404.

Once the permanent security association (SA) 426 is established, the S-CSCF 406 sends a NOTIFY message 430 to the P-CSCF 404, and a corresponding NOTIFY message 428 is forwarded to the UE device 402. The subscription lifetime contained in the NOTIFY messages corresponds to the lifetime of the permanent SA 426. The NOTIFY messages include a specification of the lifetime of the subscription to the event package as well as a list of authorized Universal Resource Identifiers (URIs) for the UE device 402. The NOTIFY messages also specify a lifetime for that subscription. The processing of the UE device 402 thus knows 434 of the lifetime of the permanent SA 426 and the full set of URIs that the UE device is authorized to use and is then able to determine the time remaining in the subscription, and therefore the time remaining for the permanent security association 426. The full set of URIs that the UE device 402 is authorized to use, as conveyed in the NOTIFY message 428, is available for use by the UE device 402.

The P-CSCF then subscribes 436, with a SUBSCRIBE request 438, to an event package, such as a specially defined security event package, to determine the lifetime of the subscription and authorized URIs for the UE device 402 using this permanent SA 426. The S-CSCF 406 responds with a NOTIFY message 440 for the subscribed package. The UE device 402 is then able to originate, at 444, any type of SIP session it desires, and is able to transmit 442 any type of IMS related message, such as REGISTER, INVITE, SUBSCRIBE, MESSAGE, and so forth.

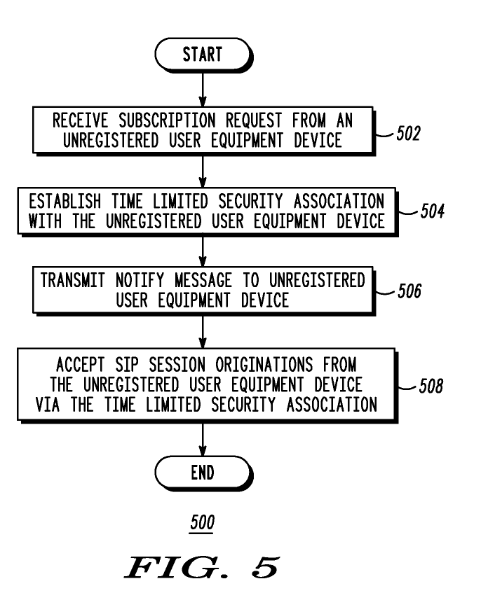

FIG. 5 illustrates a secure and authenticated session layer path set-up processing 500, by a security proxy, such as security proxy 112, in accordance with one embodiment of the present invention. The secure and authenticated session layer path set-up processing 500 begins by receiving, at step 502, a subscription request, at the security proxy, from an unregistered user equipment device. In response to receiving this subscription request, the security proxy establishes, at step 504, a time limited security association with the unregistered user equipment device. The security proxy then transmits, at step 506, a NOTIFY message to the unregistered user equipment device. This notify message, as discussed above, include a specification of the lifetime of the time limited security association. The security proxy then accepts, at step 508, Session Initiation Protocol (SIP) session originations from the unregistered user equipment device via the time limited security association.

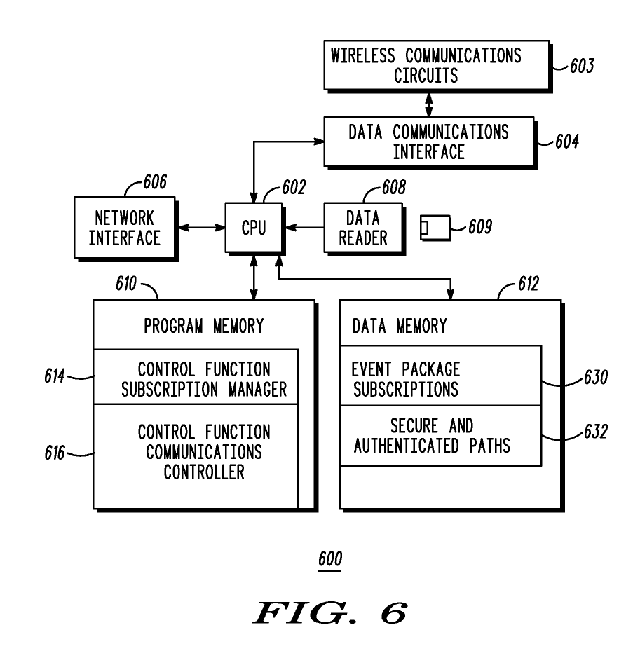

FIG. 6 illustrates a block diagram of a security proxy processor 600, for example, as is included in the S-CSCF 116 or the S-CSCF 406, in accordance with one embodiment of the present invention. The security proxy processor 600 in this example performs the processing of the various Call Session Control Functions employed in an IP Multimedia Subsystem (IMS). In addition to the modified CSCF processing described in this specification, the security proxy processor 600 performs the conventional CSCF processing as required by the various protocols implemented by the various embodiments. In order to more clearly and succinctly describe one embodiment of the present invention, the conventional IMS processing that is not modified is not described in detail.

The security proxy processor 600 includes a CPU 602 that performs the programmed processing defined by processing programs, as is described below. The CPU 602 of some embodiments of the present invention are able to include programmable microprocessors, pre-configured or reconfigurable gate arrays, and/or any other suitable signal processing hardware capable of being configured or re-configured to perform pre-programmed or re-programmable tasks. The CPU 602 accepts data to be transmitted and provides received data through a data communications interface 604. In one embodiment of the present invention, the data communications interface operates in conjunction with wireless communications circuits 603 to provide a wireless IMS network that is accessible to UE device operating in a wireless mode. As is known to practitioners in the relevant arts, the configuration of an IMS network is able to include intervening processing nodes between a particular security proxy processor and an actual wireless interface, such as those located at the first antenna tower 104.

The CPU 602 further accepts a computer program product that is encoded on a physical media 609 that is read by data reader 608. Data reader 608 reads a computer readable medium 609 to extract a computer program, and provides that computer program to CPU 602 to be encoded into program memory 610, described in more detail below.

The CPU is further able to exchange data through a network interface 606. Network interface 606 connects this particular security proxy processor to, for example, other processing nodes within an IMS infrastructure. The network interface 606 is able to connect, for example, an S-CSCF to one or more P-CSCFs.

The security proxy processor 600 includes a program memory 610 that stores programs that define the processing defined for the CPU 602. The program memory 610 of one embodiment of the present invention includes a control function subscription manager program 614 that receives, at the security proxy from the UE device through the secure and authenticated session layer path prior to the UE device registering with the security proxy, a SUBSCRIBE request for an event package from the security proxy in order to extend a lifetime of the secure and authenticated session layer path beyond a lifetime of a session initiated by the session initiation protocol request, wherein the event package comprises information defining the secure and authenticated session layer path.

The program memory 610 further includes a control function communications controller program 616 that accepts, at the security proxy from a UE device, a session initiation protocol request other than a REGISTER request and responds to the a session initiation protocol request by sending a challenging response message to the UE device. The control function communications controller program 616 also accepts, at the security proxy from a UE device, an authenticating response containing information sufficient to authenticate the user equipment node, and establishes a secure and authenticated session layer path between the security proxy and the user equipment node based upon the authenticating response.

The security proxy processor 600 includes a data memory 612. Data memory 612 stores data that support processing performed by CPU 602. The data memory 612 of one embodiment of the present invention includes event package subscriptions 630, which define event package subscription requests submitted by UE devices. The data memory 612 further includes secure and authenticated session layer paths data 632, which stores the data required to support secure and authenticated communications paths to the UE devices. Data stored in the secure and authenticated session layer paths data 632 includes, for example, User Equipment (UE) identifiers, encryption key data for the secure communications links, and the like.

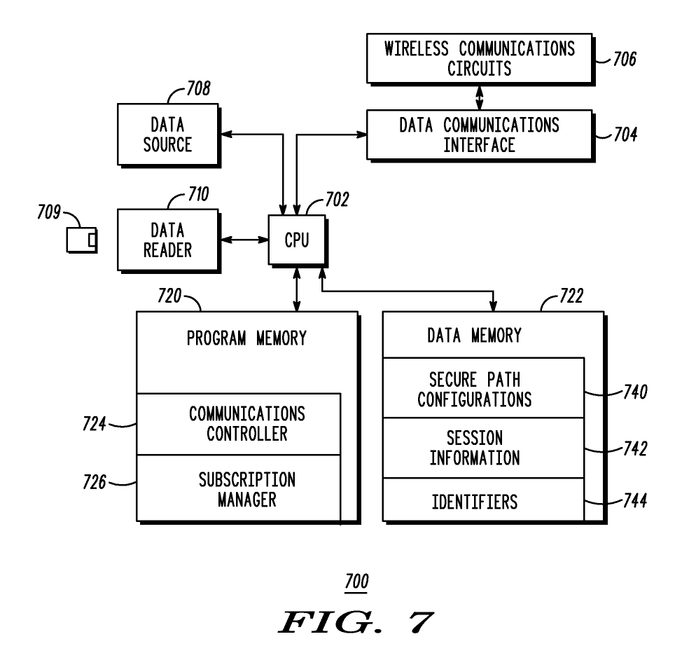

FIG. 7 illustrates a User Equipment (UE) processor 700 for use in a UE device, or node, such as a processor of the UE device 102 or of the UE device 402, in accordance with one embodiment of the present invention. Similar to the security proxy processor 600, the UE processor 700 includes a CPU 702, a data communications interface 704, wireless communications circuits 706, and data reader 710 that reads physical media 709. These components are similar to the corresponding components described above, but in one embodiment are optimized for a portable, battery operated device.

The UE processor 700 further exchanges data with a data source 708. Data source 708 is a user data processing device that, for example, performs user interface functions and other data processing, such as Personal Data Assistant (PDA) functions, voice and/or voice and video communications, and the like.

The UE processor 700 also contains a program memory 720 that stores programs that define the processing defined for the CPU 702. The program memory 720 of one embodiment of the present invention includes a communications session controller program 724 that transmits to a security proxy from the corresponding UE device, prior to registering with the security proxy, a session initiation protocol request other than a REGISTER request. The communications session controller program 724 also responds, from the UE device prior to registering with the security proxy, to a session initiation protocol challenging response message with an authenticating response containing information sufficient to authenticate the UE device with the security proxy and sufficient to create a secure and authenticated session layer path between the UE device and the security proxy, wherein the session initiation protocol challenging response message was sent from the security proxy in response to the transmitting.

The program memory 720 also includes a subscription manager program 726 that subscribes, at the UE device through the secure and authenticated session layer path prior to registering with the security proxy, to an event package from the security proxy in order to extend a lifetime of the secure and authenticated session layer path beyond a lifetime of a session initiated by the session initiation protocol request.

The UE processor 700 also includes a data memory 722. Data memory 722 stores data that support processing performed by CPU 702. The data memory 722 of one embodiment of the present invention includes secure path configurations 740 that include, for example, encryption key data, authentication timeframes, and other relevant data to define secure communications paths from the UE device to, for example, a S-CSCF. Data memory 722 further includes session information 742 that stores data associated with communications sessions in which the UE device is engaged. The data memory 722 also includes identifiers 744, which store network communications identifiers that are able to be used by the UE device.

One embodiment of the present invention creates and uses a new “security” SIP event package for establishing and maintaining a secure IMS connection between a UE device and an IM core network that is similar to a secure IMS connection conventionally established using REGISTER requests, except that no registration is used. A UE device establishes a secure IMS connection by subscribing to the “security” event package. The “security” event package is serviced by an S-CSCF of the IMS core network, which acts a notifier for the package. SIP SUBSCRIBE requests/responses for the “security” event package of one embodiment carry IMS AKA authentication headers and security mechanism agreement headers (Security-Client, Security-Server, Security-Verify) similar to those currently carried in REGISTER requests and responses. The IMS AKA authenticates the private user identity and the security mechanism agreement negotiates algorithms used by the ipsec-3gpp security mechanism for establishing IPsec Security Associations between the UE device and the P-CSCF. The resulting subscription dialog route-set defines the service route of the secure connection between the UE device and the S-SCSF and is used as the initial route-set for subsequent SIP requests sent over the connection.

An IMS user, such as UE devices 102 and 402, of one embodiment of the present invention is able to establish multiple “security” SIP event package subscriptions to the IM core. Each subscription is able to use a different UE contact address and a different P-CSCF. This enables the IMS user to establish multiple secure IMS connections via different IP-CANs and/or visited IMS networks.

One embodiment of the present invention provides the following benefits over conventional IMS operations: 1) an IMS subscriber is able to originate sessions using an un-registered public user identity (AOR); 2) an IMS subscriber is able to initiate sessions without modification of its AOR binding (or having to use a fake binding); 3) IMS session mobility is achieved without modification of existing AOR bindings; 4) multiple secure IMS security connections for the same public user ID and private user ID combination (e.g. across multiple IP-CANs) are able to be created; 5) new secure IMS connections are able to be created without causing existing sessions to be terminated; 6) another secure IMS connection on which to create IMS sessions is able to be established, and a way to be aware of the lifetime and status of the secure path is provided; 7) an IMS network is able to manage secure IMS connection independently of any registration state; 8) an IMS network is able to manage secure IMS connection independently of existing established sessions; and 9) IMS registrations are greatly simplified.

The present invention may also be embedded in a computer program product, which comprises all the features enabling the implementation of the methods described herein, and which—when loaded in a computer system—is able to carry out these methods. Computer program means or computer program in the present context mean any expression, in any language, code or notation, of a set of instructions intended to cause a system having an information processing capability to perform a particular function either directly or after either or both of the following a) conversion to another language, code or, notation; and b) reproduction in a different material form.

Each computer system may include, inter alia, one or more computers and at least one computer readable medium that allows the computer to read data, instructions, messages or message packets, and other computer readable information. The computer readable medium may include non-volatile memory, such as ROM, Flash memory, Disk drive memory, CD-ROM, SIM card, and other permanent storage. Additionally, a computer medium may include, for example, volatile storage such as RAM, buffers, cache memory, and network circuits.

The terms program, software application, and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

Reference throughout the specification to “one embodiment” means that a particular feature, structure, or characteristic described in connection with the embodiment is included in at least one embodiment of the present invention. Thus, the appearances of the phrases “in one embodiment” in various places throughout the specification are not necessarily all referring to the same embodiment. Furthermore, the particular features, structures, or characteristics may be combined in any suitable manner in one or more embodiments. Moreover these embodiments are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in the plural and visa versa with no loss of generality.

While the various embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A method for establishing a secure and authenticated session layer path between a user equipment device and a security proxy, the method comprising:
transmitting to the security proxy from the user equipment device, prior to registering with the security proxy, a session initiation protocol request other than a REGISTER request; and
responding, from the user equipment device prior to registering with the security proxy, to a session initiation protocol challenging response message with an authenticating response containing information sufficient to authenticate the user equipment device with the security proxy and sufficient to create a secure and authenticated session layer path between the user equipment device and the security proxy, wherein the session initiation protocol challenging response message was sent from the security proxy in response to the transmitting.

2. The method of claim 1, wherein the secure and authenticated session layer path is configured to communicate data according to IP Multimedia Subsystem protocols, and wherein the security proxy comprises a serving call session control function.

3. The method of claim 1, further comprising:
subscribing, at the user equipment device through the secure and authenticated session layer path prior to registering with the security proxy, to an event package from the security proxy in order to extend a lifetime of the secure and authenticated session layer path beyond a lifetime of a session initiated by the session initiation protocol request.

4. The method of claim 3, wherein the transmitting comprises transmitting a session initiation protocol INVITE request.

5. The method of claim 3, wherein the subscribing comprises transmitting a session initiation protocol SUBSCRIBE request that contains at least one universal resource identifier associated with the user equipment device, the method further comprising:
receiving, from the security proxy in response to the session initiation protocol SUBSCRIBE request, a session initiation protocol NOTIFY message, the session initiation protocol NOTIFY message comprising at least one of a list of all authorized universal resource identifiers for the user equipment device and a lifetime of the secure and authenticated session layer path.

6. The method of claim 1, wherein the session initiation protocol request comprises a session initiation protocol SUBSCRIBE request for an event package from the security proxy, the method further comprising:
receiving, from the security proxy in response to the session initiation protocol SUBSCRIBE request, a session initiation protocol NOTIFY message comprising at least one of a list of all authorized universal resource identifiers for the user equipment device and a lifetime of the secure and authenticated session layer path.

7. The method of claim 6, wherein the event package comprises a session initiation protocol REGISTER event package.

8. The method of claim 6, wherein the event package comprises a unique event package that is associated with establishing secure and authenticated session layer paths established prior to registration.

9. The method of claim 1, further comprising communicating, at the user equipment device, a session initiation protocol request over the secure and authenticated session layer path based upon authentication provided by the secure and authenticated session layer path, the communicating comprising at least one of transmitting and receiving the session initiation protocol request.

10. The method of claim 9, wherein the user equipment device had established a previously established secure and authenticated session layer path with the security proxy through a first edge proxy server, prior to the establishing the secure and authenticated session layer path, and is maintaining an existing session initiation protocal communication session with the security proxy through the previously established secure and authenticated session layer path, wherein the secure and authenticated a session layer path communicates data between the user equipment device and the security proxy through a second edge proxy and wherein the communicating comprises:
transmitting a session initiation protocol INVITE with replace message to the security proxy through a second edge proxy, wherein the session initiation protocol INVITE with replace message replaces the existing session initiation protocol communication session with a new session initiation protocol communication session operating through the secure and authenticated session layer path.

11. A method for establishing an IP Multimedia subsystem session between a security proxy and a user equipment device, the method comprising:
accepting, at the security proxy from the user equipment device, a session initiation protocol request other than a REGISTER request;
responding to the a session initiation protocol request by sending a challenging response message to the user equipment device;
accepting, at the security proxy from a user equipment device, an authenticating response containing information sufficient to authenticate the user equipment device; and
establishing a secure and authenticated session layer path between the security proxy and the user equipment device based upon the authenticating response.

12. The method of claim 11, further comprising:
receiving, at the security proxy from the user equipment device through the secure and authenticated session layer path prior to registering with the security proxy, a SUBSCRIBE request for an event package from security proxy in order to extend a lifetime of the secure and authenticated session layer path beyond a lifetime of a session initiated by the session initiation protocol request, wherein the event package comprises information defining the secure and authenticated session layer path.

13. The method of claim 12, wherein the event package comprises one of a session initiation protocol REGISTER event package and a unique event package that is associated with establishing secure and authenticated session layer paths established prior to registration, wherein the unique event package comprises at least one of a list of all universal resource identifiers associated with the user equipment device and a specification of the lifetime of the secure and authenticated session layer path.

14. The method of claim 12, wherein the receiving comprises receiving a session initiation protocol SUBSCRIBE request that contains at least one universal resource identifier associated with the user equipment device, the method further comprising:
transmitting, from the security proxy in response to the session initiation protocol SUBSCRIBE request, a session initiation protocol NOTIFY message, the session initiation protocol NOTIFY message comprising at least one of a list of all authorized universal resource identifiers for the user equipment device and a lifetime of the secure and authenticated session layer path.

15. The method of claim 11, wherein the session initiation protocol request comprises a session initiation protocol SUBSCRIBE request that contains at least one universal resource identifier associated with the user equipment device, and where in the method further comprises:
transmitting, in response to the establishing and prior to registration of the user equipment device, a session initiation protocol NOTIFY message to the user equipment device; and
accepting, at the security proxy subsequent to the accepting the authenticating response and prior to registration of the user equipment device, a session initiation protocol session request from the user equipment device over the secure and authenticated session layer path.

16. The method of claim 15, wherein the session initiation protocol SUBSCRIBE request requests subscription to one of session initiation protocol REGISTER event package and a unique session initiation protocol event package that is associated with establishing secure and authenticated session layer paths established prior to registration, wherein the unique event package comprises at least one of a list of all universal resource identifiers associated with the user equipment device and a specification of the lifetime of the secure and authenticated session layer path.

17. The method of claim 15, wherein the user equipment device had established a previously established secure and authenticated session layer path with the security proxy through a first edge proxy, prior to the establishing the secure and authenticated session layer path, and is maintaining an existing session initiation protocol communication session with the security proxy through the previously established secure and authenticated session layer path, wherein the secure and authenticated session layer path communicates data between the user equipment device and the security proxy through a second edge proxy, and wherein the session initiation protocol session request comprises a session initiation protocol INVITE with replace message, wherein the session initiation protocol INVITE with replace message replaces the existing session initiation protocol communication session with new session initiation protocol communication session operating through the secure and authenticated session layer path.

18. The method of claim 17, further comprising accepting, from the second edge proxy, a session initiation protocol SUBSCRIBE request for the session initiation protocol event package and sending, in response to accepting the session initiation protocol SUBSCRIBE request from the second edge proxy, a second session initiation protocol NOTIFY message, wherein the second session initiation protocol NOTIFY message comprises at least one of a list of all universal resource identifiers associated with the user equipment device and a specification of the lifetime of the secure and authenticated session layer path.

19. The method of claim 17, wherein the secure and authenticated session layer path is configured to communicate data according to the IP Multimedia Subsystem protocol, wherein the security proxy comprises a serving call session control function, and wherein the second edge proxy comprises a proxy call session control function.

20. A user equipment device for use with a wireless data communication system, the user equipment device comprising:
a communications session controller adapted to transmit to a security proxy, prior to registering with the security proxy, a session initiation protocol request other than a REGISTER request.
the communications session controller further adapted to respond, prior to registering with the security proxy, to a session initiation protocol challenging response message with an authenticating response containing information sufficient tot authenticate the user equipment device with the security proxy and sufficient to create a secure and authenticated session layer path between the user equipment device and the security proxy, wherein the session initiation protocol challenging response message was sent from the security proxy in response to the transmitting.
